(19) United States
(12) Patent Application Publication
(10) Pub. No.: US 2026/0295729 A1
(43) Pub. Date: Oct. 1, 2026

(54) WELDING APPARATUS AND METHOD FOR MANUFACTURING POWER STORAGE DEVICE

(71) Applicant: Prime Planet Energy & Solutions, Inc., Tokyo (JP)

(72) Inventor: Kazuki TAMURA, Takasago-shi (JP)

(21) Appl. No.: 19/578,891

(22) Filed: Mar. 26, 2026

(30) Foreign Application Priority Data
Apr. 1, 2025 (JP) 2025-060858

(51) Int. Cl. B23K 26/14; B23K 26/21; B23K 37/04; B23K 101/36

(52) U.S. Cl. CPC B23K 26/1464; B23K 26/21; B23K 37/0426; B23K 2101/36

(57) ABSTRACT

A welding apparatus includes a workpiece disposition unit, a laser irradiation device, and an inert gas supply unit. An assembly of a case body and a sealing plate is disposed on the workpiece disposition unit with an opening facing upward with the sealing plate attached. The laser irradiation device is disposed above the workpiece disposition unit. The inert gas supply device includes a nozzle at a position that is lower than an upper end of the case body of the assembly disposed on the workpiece disposition unit. The nozzle has an outlet port configured to blow inert gas toward a boundary between the case body and the sealing plate from a position lower than an upper end of the case body within the assembly.

### CROSS REFERENCE TO RELATED APPLICATION

The present application claims the benefit of priority to Japanese Patent Application No. 2025-060858, filed on Apr. 1, 2025, and the disclosure of which is hereby incorporated by reference in its entirety.

### BACKGROUND

The present invention relates to a welding apparatus and a method for manufacturing a power storage device.

Japanese Patent Application Laid-Open Publication No. 2013-197034 discloses a welding apparatus for laser welding a case body and a cover plate of a secondary battery. This welding apparatus includes an inert gas supply means for supplying an inert gas toward a boundary (an intended welding point) between the case body and the cover plate during laser welding. The inert gas supply means has an inert gas supply port positioned above the intended welding point. During laser welding using such a welding apparatus, an inert gas is supplied from above the intended welding point toward the intended welding point, and the boundary between the case body and the cover plate is irradiated with laser light under an inert gas atmosphere. Laser welding under the inert gas atmosphere reduces welding defects.

### SUMMARY

The present inventors have an intention of providing a welding apparatus and a method for manufacturing a power storage device that are suitable for suppressing cumulative deposition of fumes generated during laser welding using a welding apparatus for welding a case body and a sealing plate of the power storage device near the laser welding point within the apparatus.

A welding apparatus disclosed herein is a welding apparatus configured to weld a case body and sealing plate to each other, a power storage device comprising the case body and the sealing plate, the case body having an opening, the sealing plate attached to the opening, the welding apparatus including: a workpiece disposition unit on which an assembly of the case body and the sealing plate is disposed with the opening facing upward with the sealing plate attached; a laser irradiation device disposed above the workpiece disposition unit; and an inert gas supply device, wherein the inert gas supply device includes a nozzle at a position that is lower than an upper end of the case body of the assembly disposed on the workpiece disposition unit, and the nozzle has an outlet port configured to blow inert gas toward a boundary between the case body and the sealing plate from a position lower than the upper end of the case body within the assembly, with respect to the assembly disposed on the workpiece disposition unit. Such a welding apparatus is suitable for suppressing cumulative deposition of fumes generated in the vicinity of the laser welding point within the apparatus during laser welding.

### BRIEF DESCRIPTION OF THE DRAWINGS

FIG. 1 is a perspective view schematically showing a power storage device;

FIG. 2 is an exploded perspective view of the power storage device;

FIG. 3 is a perspective view showing a welding device according to one embodiment of the present invention;

FIG. 4 is a partially enlarged cross-sectional view of the welding apparatus shown in FIG. 3;

FIG. 5 is a plan view showing a clamp unit of the welding apparatus shown in FIG. 3;

FIG. 6 is a perspective view of a short side clamp (holding member);

FIG. 7 is a top plan view of the short side clamp shown in FIG. 6;

FIG. 8 is vertical cross-sectional view of a second clamp taken in the line VIII-VIII of FIG. 7;

FIG. 9 is a flowchart showing an example of a method for manufacturing a power storage device according to one embodiment of the present invention; and

FIG. 10 is an enlarged cross-sectional view showing a welding step.

### DETAILED DESCRIPTION OF THE PREFERRED EMBODIMENTS

Hereinafter, embodiments of a technology disclosed herein will be described with reference to the drawings. It is needless to say that the embodiments described herein are not intended to specifically limit the present invention. Each drawing is drawn schematically and does not necessarily reflect the actual objects. Moreover, in each drawing, members and parts having the same function will be given the same reference numerals, and redundant description thereof will be omitted or simplified. Moreover, in this specification, a notation such as “X to Y” indicating a numerical range means “not less than X and not more than Y” unless otherwise specified.

The term “the power storage device” used therein refers to a device that can be charged and discharged. The power storage device includes batteries generally called lithium-ion batteries and lithium secondary batteries, as well as batteries such as lithium polymer batteries and nickel-metal hydride batteries. A secondary battery generally refers to a battery that can be repeatedly charged and discharged due to the transfer of charge carriers between positive and negative electrodes. For power storage devices, an electrolytic solution or a solid electrolyte may be used as the electrolyte. For example, the secondary battery used herein may be a secondary battery using a so-called liquid-based electrolyte or may be a so-called all-solid-state battery using a solid electrolyte. Moreover, the power storage device also includes capacitors such as electric double layer capacitors and lithium-ion capacitors.

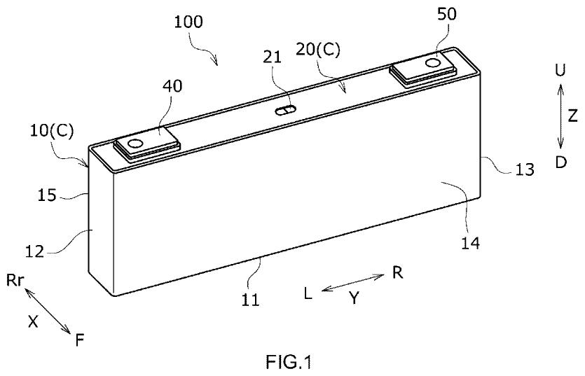

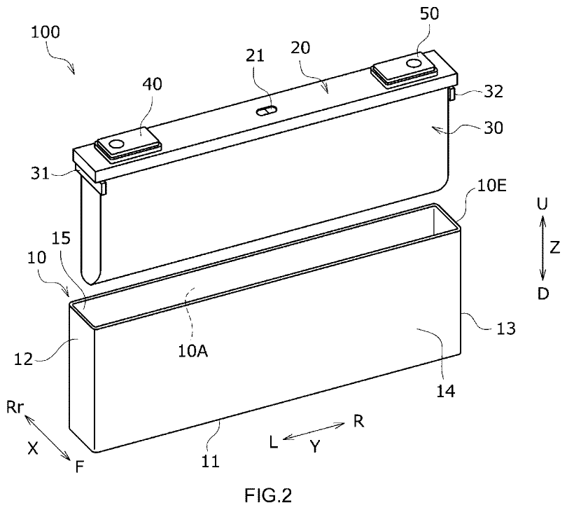

FIG. 1 is a perspective view showing a power storage device 100 manufactured by a method for manufacturing a power storage device according to one embodiment of the present invention, which will be described later. FIG. 2 is an exploded perspective view of the power storage device. Reference symbols F, Rr, L, R, U, and D in the drawings represent front, rear, left, right, top, and bottom, respectively. In the following description, the thickness direction of the power storage device 100 is defined as the X direction, the width direction perpendicular to the thickness direction is defined as the Y direction, and the vertical direction perpendicular to the width and thickness directions is defined as the Z direction.

As shown in FIGS. 1 and 2, power storage device 100 includes a case body 10, a sealing plate 20, an electrode body 30 (shown in FIG. 2), a positive terminal 40, a negative terminal 50, and an electrolyte (not shown). In this embodiment, the power storage device 100 is a lithium-ion secondary battery.

The case body 10 and the sealing plate 20 forms a case C for the power storage device 100. The case C is a housing for the power storage device 100. In this embodiment, case C has an outer shape of flatness and the rectangular parallelepiped shape (e.g., square shape). The case C houses the electrode body 30 and the electrolyte. In this embodiment, the thickness (external dimension in the X direction) of the case C is, for example, not less than 3 cm and, for example, not more than 6 cm, the width (external dimension in the Y direction) of the case Cis, for example, not less than 30 cm and, for example, not more than 50 cm, and the height (external dimension in the Z direction) of the case C is, for example, not less than 6 cm and, for example, not more than 20 cm. Such a relatively large case C is preferable in terms of increasing the capacity of the power storage device 100 since a relatively large electrode body 30 can be housed therein.

As shown in FIG. 2, the case body 10 is configured in a substantially rectangular parallelepiped, and in this embodiment, is a square cylindrical case having an opening 10A. Specifically, the case body 10 has an edge portion 10E that defines the opening 10A at one end in the Z direction (the upper end in the drawing). The edge portion 10E surrounds the opening 10A. Moreover, case body 10 has a shape extending in the Y direction.

The case body 10 has a bottom surface 11, a pair of narrow side surfaces 12, 13, and a pair of wide side surfaces 14, 15 as case walls. In the case body 10, the bottom surface 11 is positioned at the lower end in the Z direction (the end opposite to the opening 10A). The bottom surface 11 has a short side extending in the X direction and a long side extending in the Y direction and has a substantially rectangular shape extending in both the X and Y directions. Each of the narrow side surfaces 12, 13 has a short side extending in the X direction and a long side extending in the Z direction and has a substantially rectangular shape extending in both the X and Z directions. The pair of narrow side surfaces 12,13 faces in the Y direction each other. Each of the wide side surfaces 14, 15 has a long side extending in the Y direction and a short side extending in the Z direction and has a substantially rectangular shape extending in both the Y and Z directions. The pair of wide side surfaces 14, 15 faces in the X direction each other. One short side of the wide side surface 14 is connected to one long side of the narrow side surface 12, and the other short side of the wide side surface 14 is connected to one long side of the narrow side surface 13. One short side of the wide side surface 15 is connected to the other long side of the narrow side surface 12, and the other short side of the wide side surface 15 is connected to the other long side of the narrow side surface 13. The lower ends of the narrow side surfaces 12, 13 and the wide side surfaces 14, 15 in the Z direction are connected to the bottom surface 11. The upper ends of the narrow side surfaces 12, 13 and the wide side surfaces 14, 15 in the Z direction form the edge portion 10E of the case body 10. Such a case body 10 is made of metal. Examples of component materials that can be used to form the case body 10 include aluminum, aluminum alloys, iron, and iron alloys. From the viewpoint of realizing both a lighter weight and the required rigidity of the case body 10, the material of the case body 10 is preferably aluminum or an aluminum alloy containing aluminum as the main component material.

The sealing plate 20 is a member for sealing the opening 10A of the case body 10. The sealing plate 20 seals the opening 10A by being welded to the edge portion 10E of the case body 10 along its entire periphery. The sealing plate 20 is configured in a substantially rectangular plate shape (i.e., a flat plate member that is substantially rectangular in plan view) and has a shape and size capable of closing the opening 10A. Examples of component materials that can be used to form the sealing plate 20 include aluminum, aluminum alloys, iron, and iron alloys. From the viewpoint of realizing a lighter weight of the case body 10, the material of the sealing plate 20 is preferably aluminum or an aluminum alloy containing aluminum as the main component material.

In this embodiment, the sealing plate 20 includes a gas exhaust valve 21. The gas exhaust valve 21 is a thin wall portion configured to break when pressure inside the case C exceeds a predetermined value. The gas inside the case C to be exhausted to the outside of the case C due to the break of the gas exhaust valve 21, thereby preventing or suppressing a further increase in pressure inside the case C. The gas exhaust valve 21 is disposed at a center portion of the sealing plate 20 in the Y direction.

The electrode body 30 (shown in FIG. 2) is housed in the case C or the case body 10. The electrode body 30 includes a positive electrode and a negative electrode. In this embodiment, the electrode body 30 is a so-called wound electrode body. The electrode body 30 is formed by winding a laminated body, which is obtained by laminating a strip-shaped positive electrode and a strip-shaped negative electrode with a strip-shaped separator (not shown) interposed therebetween, in the longitudinal direction around a winding axis. Instead of such a configuration, the electrode body 30 may be a laminated electrode body, which is obtained by laminating a rectangular positive electrode and a rectangular negative electrode in a state insulated from each other.

In this embodiment, the electrode body 30 has a flat outer shape. The electrode body 30 has a pair of curved portions and a pair of flat surfaces connecting the pair of curved portions. Such an electrode body 30 (wound electrode body) is housed in the case C with its winding axis oriented along the Y direction. The pair of curved portions of the electrode body 30 respectively face the bottom surface 11 and the sealing plate 20 of the case C. Instead of such a housing mode, the electrode body 30 may be housed in the case C with its winding axis oriented along the Z direction.

The positive electrode of the electrode body 30 includes, for example, a laminated structure of a positive electrode collector and a positive electrode active material layer. The positive electrode collector is preferably a strip-shaped conductive metal foil. Examples of component materials for the positive electrode collector include aluminum, aluminum alloys, nickel, and stainless steel, and aluminum is preferable. The positive electrode active material layer is provided, for example, in a strip shape along the longitudinal direction on at least one surface of the strip-shaped positive electrode collector. The positive electrode active material layer includes a positive electrode active material capable of reversibly absorbing and releasing charge carriers, and a binder. The positive electrode active material is preferably a lithium transition metal composite oxide. Specific examples of such an oxide include lithium cobalt composite oxide, lithium manganese composite oxide, lithium nickel composite oxide, lithium nickel manganese composite oxide, lithium nickel cobalt composite oxide, and lithium nickel cobalt manganese composite oxide. An example of the binder is polyvinylidene fluoride (PVDF). The strip-shaped positive electrode collector has an exposed portion at one end portion in the width direction (short direction) thereof where no positive electrode active material layer is laminated and formed. A plurality of positive electrode tabs (which are parts of the positive electrode collector) are formed in the exposed portion at predetermined intervals in the longitudinal direction of the positive electrode collector. In the electrode body 30 as the wound electrode body, a plurality of such positive electrode tabs are stacked to form a positive electrode tab group (not shown). The positive electrode tab group is positioned on one end side of the electrode body 30 in the Y direction (the left end side in FIG. 2) and is connected to the positive electrode collection unit 31. Examples of component materials for the positive electrode collection unit 31 include aluminum and aluminum alloys.

The negative electrode of the electrode body 30 includes, for example, a laminated structure of a negative electrode collector and a negative electrode active material layer. The negative electrode collector is preferably a strip-shaped conductive metal foil. Examples of component materials for the negative electrode current collector include copper, copper alloys, nickel, and stainless steel, and copper foil is preferable. The negative electrode active material layer is provided, for example, in a strip shape along the longitudinal direction on at least one surface of the strip-shaped negative electrode collector. The negative electrode active material layer includes a negative electrode active material capable of reversibly absorbing and releasing charge carriers, and a binder. Examples of the negative electrode active material include carbon materials such as graphite and carbon. Examples of binders for the negative electrode active material include styrene butadiene rubber (SBR) and carboxymethyl cellulose (CMC). The strip-shaped negative electrode collector has an exposed portion at one end portion in the width direction (short direction) thereof where no negative electrode active material layer is laminated and formed. A plurality of negative electrode tabs (which are parts of the negative electrode collector) are formed in the exposed portion at predetermined intervals in the longitudinal direction of the negative electrode collector. In the electrode body 30 as the wound electrode body, a plurality of such negative electrode tabs are stacked to form a negative electrode tab group (not shown). The negative electrode tab group is positioned on the other end side of the electrode body 30 in the Y direction (the right end side in FIG. 2) and is connected to the negative electrode collection unit 32. Examples of component materials for the negative electrode collection unit 32 include copper and copper alloys.

The separator is a member for insulating between the positive electrode active material layer and the negative electrode active material layer from each other while holding an ion-conductive electrolyte between both layers. The separator is preferably a porous resin sheet made of polyolefin resin. Examples of polyolefin resins include polyethylene (PE) and polypropylene (PP). On the surface of the separator, a heat resistance layer (HRL) containing an inorganic filler may be provided. Examples of component materials of the inorganic filler include alumina, boehmite, aluminum hydroxide, and titania.

As shown in FIGS. 1 and 2, the positive electrode terminal 40 is attached to the sealing plate 20. For example, the sealing plate 20 has a terminal opening that passes therethrough in the thickness direction, and the positive electrode terminal 40 is attached to the opening with a gasket made of an insulating material interposed between the sealing plate 20 and the terminal opening. The positive terminal 40 can be attached to the sealing plate 20 by, for example, crimping, or caulking. In this embodiment, the positive terminal 40 is positioned between the narrow side surface 12 of the case body 10 and the gas exhaust valve 21 in the Y direction. Moreover, the positive terminal 40 is exposed to the outside of the case C and is also exposed to the inside of the case C. In the inside of the case C, the positive terminal 40 is connected to the positive electrode collection unit 31. The positive terminal 40 is electrically connected to the electrode body 30 through the positive electrode collection unit 31. Such a positive terminal 40 is preferably made of metal, and more preferably composed of aluminum or an aluminum alloy.

The negative terminal 50 is also attached to sealing plate 20 (the attachment method instruction is the same as that described above for the positive terminal 40). In this embodiment, the negative terminal 50 is positioned between the narrow side surface 13 of the case body 10 and the gas exhaust valve 21 in the Y direction. Moreover, the negative terminal 50 is exposed to the outside of the case C and is also exposed to the inside of the case C. In the inside of the case C, the negative terminal 50 is connected to the negative electrode collection unit 32. The negative terminal 50 is electrically connected to the electrode body 30 through the negative electrode collection unit 32. Such a negative terminal 50 is preferably made of metal, and more preferably composed of copper or a copper alloy.

The electrolyte is contained inside the case C together with the electrode body 30. The electrode body 30 is impregnated with the electrolyte. The electrolyte is typically a nonaqueous liquid electrolyte (non-aqueous electrolyte) containing a nonaqueous solvent and a supporting electrolyte. The nonaqueous solvent contains, for example, a carbonate such as ethylene carbonate (EC), dimethyl carbonate (DMC), or ethyl methyl carbonate (EMC). The supporting electrolyte salt is, for example, a fluorine-containing lithium salt. Examples of fluorine-containing lithium salts include lithium hexafluorophosphate (LiPF₆) and lithium bis(fluorosulfonyl)imide (LiN(SO₂F)₂). Excess electrolyte that does not impregnate the electrode body 30 may be retained inside the case C. Instead of such an electrolyte, a solid-state electrolyte (solid electrolyte) that is integrated with the electrode body 30 may be used.

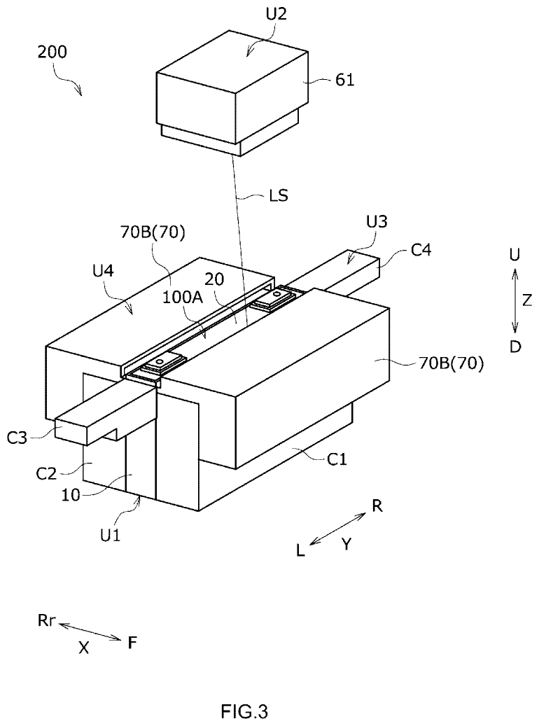

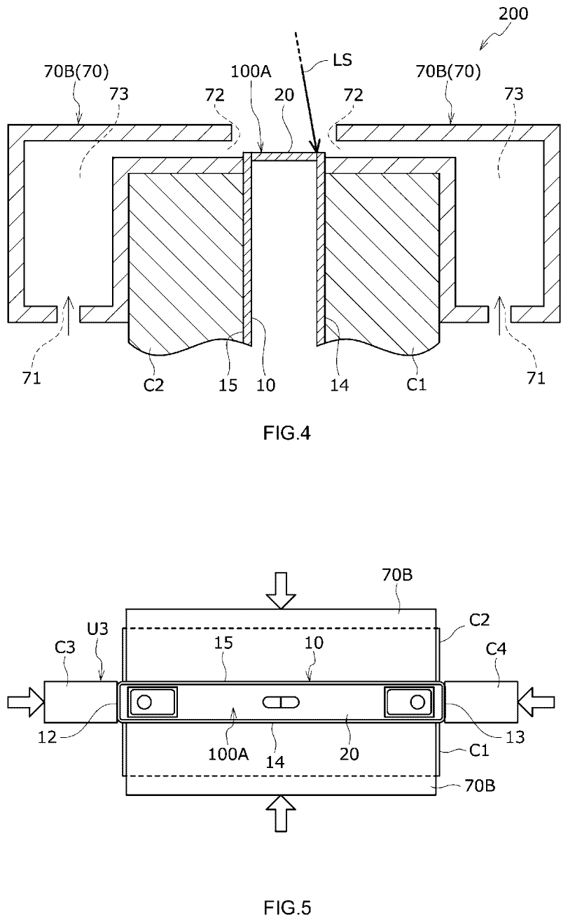

In the power storage device 100, as described above, the sealing plate 20 is welded for the entire perimeter with respect to the edge portion 10E of the case body 10. FIGS. 3 and 4 depict a welding apparatus 200 capable of performing such welding. FIG. 3 is a perspective view of the welding apparatus 200. FIG. 4 is a partially enlarged cross-sectional view of the welding apparatus 200 (the internal structure of the case body 10 is not shown). The welding apparatus 200 is a laser welding apparatus including a workpiece disposition unit U1, a laser irradiation device U2, a clamp unit U3, an inert gas supply unit U4 (inert gas supply device), and a dust collection unit (not shown), which is a laser welding apparatus to weld the case body 10 and the sealing plate 20 in the power storage device 100. Such a welding apparatus 200 is a welding apparatus (laser welding apparatus) according to one embodiment of the present invention.

The workpiece disposition unit U1 is a unit where the assembly 100A of the case body 10 and the sealing plate 20 is disposed. The assembly 100A is disposed on the workpiece disposition unit U1 with the opening 10A of the case body 10, to which the sealing plate 20 is attached, facing upward. The workpiece disposition unit U1 may have an elevatable stage on which the assembly 100A, which is a workpiece, is disposed, or may be provided midway along a conveying path of a conveyor used for conveying the assembly 100A.

The laser irradiation device U2 includes a laser unit (not shown) capable of emitting a laser for welding the case body 10 and the sealing plate 20 together, and a housing 61 for housing the laser unit, and is arranged above the workpiece disposition unit U1. The housing 61 includes a laser emission port (not shown). The laser unit includes, for example, a laser light source, a galvanometer scanner, and a predetermined optical system that forms an optical path therebetween. The galvanometer scanner includes, for example, a first galvanometer mirror capable of oscillatingly driving, and a second galvanometer mirror capable of oscillatingly driving. The laser beam emitted from the laser light source passes through the above-mentioned optical system, and then the direction of emission from the laser emission port is controlled by the galvanometer scanner. The laser irradiation device U2 controls the scanning of a laser irradiation spot on the assembly 100A disposed on the workpiece disposition unit U1.

As shown in FIGS. 3 and 5, the clamp unit U3 includes a pair of long side clamps C1, C2 and a pair of short side clamps C3, C4.

The pair of long side clamps C1, C2 are clamping jigs for pressing the edge portions 10E and its vicinities of the pair of wide side surfaces 14, 15 of the case body 10 in the assembly 100A disposed on the workpiece disposition unit U1 in a direction perpendicular to the wide side surfaces 14, 15. That is, each of the long side clamps C1, C2 is a holding member, which abuts against a region that forms a long side of the workpiece (assembly 100A) or one side surface that includes the long side, to hold the workpiece. As shown in FIGS. 3 to 5, the long side clamps C1, C2 are positioned apart in the thickness direction (X direction) of the case body 10 in the assembly 100A disposed on the workpiece disposition unit U1. The long side clamps C1, C2 face the wide side surfaces 14, 15 of the case body 10 in the assembly 100A. The long side clamps C1, C2 are each controlled to reciprocate in the X direction by a predetermined actuator. Each of the long side clamps C1, C2 may include a water pipe (not shown) therein through which cooling water passes. By the passage of the cooling water through the water pipes formed inside the long side clamps C1, C2, the long side clamps C1, C2 can also serve as a cooling mechanism for the welding points. Since the welding apparatus 200 includes the cooling mechanism for the welding point, it is suitable for suppressing temperature rise in the welding apparatus 200 due to heat generated during laser welding.

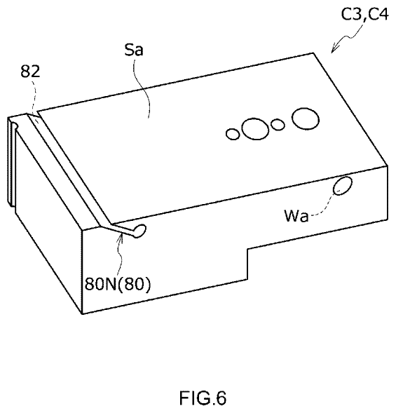

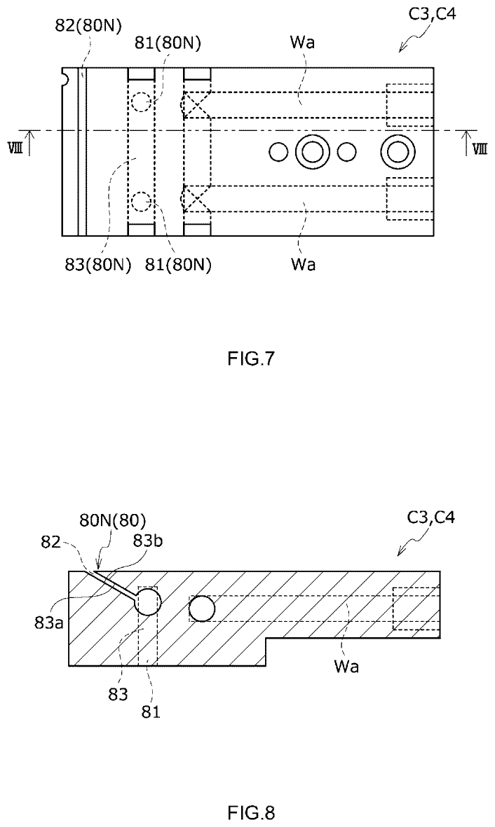

A pair of short side clamps C3, C4 (refer to FIGS. 6 to 8 for each short side clamp) are clamping jigs for pressing the edge portions 10E and its vicinities of the pair of narrow side surfaces 12, 13 of the case body 10 in the assembly 100A disposed on the workpiece disposition unit U1 in a direction perpendicular to the narrow side surfaces 12, 13. That is, each of the short side clamps C3, C4 is a holding member that abuts against a region forming a short side of the workpiece (assembly 100A) or a side surface including the short side, to hold the workpiece. As shown in FIGS. 3 and 5, the short side clamps C3, C4 are positioned apart in the width direction (Y direction) of the case body 10 in the assembly 100A disposed on the workpiece disposition unit U1. The short side clamps C3, C4 face the narrow side surfaces 12, 13 of the case body 10 in the assembly 100A. The short side clamps C3, C4 are each controlled to reciprocate in the Y direction by a predetermined actuator. Moreover, as shown in FIGS. 6 and 7, each of the short side clamps C3, C4 includes a water pipe Wa therein through which cooling water passes. Moreover, the short side clamps C3, C4 are each positioned below (at a lower position) than the upper ends of the case body 10 and the sealing plate 20 in the assembly 100A disposed on the workpiece disposition unit U1.

The inert gas supply unit U4 is an apparatus (inert gas supply apparatus) for supplying inert gas to the laser irradiation point in the assembly 100A disposed on the workpiece disposition unit U1 and includes a first supply unit 70 (refer to FIGS. 3 and 4), a second supply unit 80 (refer to FIGS. 6 to 8), and a plurality of gas supply lines (not shown).

As shown in FIGS. 3 and 4, the first supply unit 70 includes two gas supply blocks 70B. One gas supply block 70B is disposed on the long side clamp C1, and the other gas supply block 70B is disposed on the long side clamp C2. Each gas supply block 70B includes an inlet port 71, an outlet port 72, and a flow path 73 extending from the inlet port 71 to the outlet port 72.

The inlet port 71 is an opening for introducing inert gas into the flow path 73 toward the outlet port 72. The inlet port 71 is connected to a gas supply line (not shown) provided with a gas flow control valve. Inert gas is supplied to the gas supply block 70B through this line. Examples of the inert gas supplied by the inert gas supply unit U4 include nitrogen gas, argon gas, and helium gas.

The outlet port 72 is an opening for blowing the inert gas and opens on the assembly 100A side. The outlet port 72 of one of the gas supply blocks 70B opens along the boundary (one long-side intended welding line) between the wide side surface 14 of the case body 10 and the sealing plate 20 in the assembly 100A disposed on the workpiece disposition unit U1. The outlet port 72 of the other gas supply block 70B opens along the boundary (the other long-side intended welding line) between the wide side surface 15 of the case body 10 and the sealing plate 20 in the assembly 100A. In this embodiment, the outlet port 72 opens so that each long-side intended welding line is positioned within the corresponding outlet port 72 in the height direction. That is, each long-side intended welding line is positioned within a range above the lower end and below the upper end of the corresponding outlet port 72 in the height direction.

The second supply unit 80 includes two nozzles 80N for supplying the inert gas (refer to FIGS. 6 to 8 for each nozzle 80N). One nozzle 80N is formed in the short side clamp C3, and the other nozzle 80N is formed in the short side clamp C4. That is, in this embodiment, the two nozzles 80N of the second supply unit 80 are formed on the pair of short side clamps C3, C4 opposed to each other and are disposed so as to face each other via the assembly 100A disposed on the workpiece disposition unit U1. Each nozzle 80N includes an inlet port 81, an outlet port 82, and a flow path 83 extending from the inlet port 81 to the outlet port 82.

The inlet port 81 is an opening for introducing inert gas into the flow path 83 toward the outlet port 82. The inlet port 81 is connected to a gas supply line (not shown) provided with a gas flow control valve. The inert gas is supplied to the nozzle 80N through this line.

The outlet port 82 is an opening for blowing the inert gas and opens on the assembly 100A side. The outlet port 82 of one of the nozzles 80N opens along the boundary (one short-side intended welding line) between the narrow side surface 12 of the case body 10 and the sealing plate 20 in the assembly 100A disposed on the workpiece disposition unit U1. The outlet port 82 is formed in a slit shape and opens on the upper surface Sa of the short side clamp C3. The slit-shaped outlet port 82 opened on the upper surface Sa of short side clamp C3 extend along the narrow side surface 12 (one side surface) of the case body 10 in the assembly 100A. Moreover, the nozzle 80N also includes an upper wall 83a and a lower wall 83b that face each other and define the flow path 83 (gas flow path). The upper wall 83a and the lower wall 83b are inclined upward toward the narrow side surface 12 (one side surface) of the case body 10. The inclination angle is preferably not more than 40°, more preferably not more than 30°, and still more preferably not more than 25°, from the viewpoint of ease of forming the nozzle 80N (i.e., ease of producing the short side clamps C3, C4). The inclination angle is, for example, not less than 0°, preferably not less than 3°, more preferably not less than 7°, and still more preferably not less than 10°. In this embodiment, such a nozzle 80N is formed by cutting a slit into the short side clamp C3. The inclination and formation aspect of the nozzle 80N are the same as those of the other nozzle 80N.

The outlet port 82 of the other nozzles 80N opens along the boundary (one short-side intended welding line) between the narrow side surface 13 of the case body 10 and the sealing plate 20 in the assembly 100A disposed on the workpiece disposition unit U1. The outlet port 82 is formed in a slit shape and opens on the upper surface Sa of the short side clamp C4. The slit-shaped outlet port 82 opened on the upper surface Sa of short side clamp C4 extend along the narrow side surface 13 (one side surface) of the case body 10 in the assembly 100A.

As described above, the short side clamps C3, C4 are each positioned below (at a lower position) than the upper ends of the case body 10 and the sealing plate 20 in the assembly 100A disposed on the workpiece disposition unit U1. The nozzles 80N formed in such short side clamps C3, C4 are each positioned below (at a lower position) than the upper ends of the case body 10 and the sealing plate 20 in the assembly 100A disposed on the workpiece disposition unit U1. The outlet port 82 of such a nozzle 80N is positioned below the corresponding short-side intended welding line in the height direction. The height position of the outlet port 82 or the upper surface Sa is preferably 1 to 2 mm below the upper ends of the case body 10 and the sealing plate 20 in the assembly 100A. The outlet port 72 of the gas supply block 70B may be also provided below the corresponding long-side intended welding line in the height direction. In this case, the height position of the upper end of the outlet port 72 is preferably 1 to 2 mm below the upper ends of the case body 10 and the sealing plate 20 in the assembly 100A.

In the inert gas supply unit U4 as described above, the supply of inert gas by each gas supply block 70B of the first supply unit 70 and each nozzle 80N of the second supply unit 80 is configured to be individually controllable.

In this embodiment, the welding apparatus 200 includes two sets of detection sensors (not shown) for detecting whether or not the assembly 100A disposed on the workpiece disposition unit U1 is displaced (floated) from a required position in the height direction. Each detection sensor includes, for example, a light projecting unit and a light receiving unit. The light projecting unit and the light receiving unit are disposed to be spaced apart in the Y direction of the assembly 100A on the workpiece disposition unit U1. For example, in the Y direction, the light projecting unit is positioned on the opposite side to the assembly 100A with respect to the short side clamp C3, and the light receiving unit is positioned on the opposite side to the assembly 100A with respect to the short side clamp C4. A light-emitting surface of the light-projecting unit and a light-receiving surface of the light-receiving unit for the detection light are arranged so as to face each other and the detection light emitted from the detection light-emitting surface can be received by the light-receiving surface. In the height direction (Z direction of the assembly 100A), the light-emitting unit and the light-receiving unit are arranged so that the detection light passes above the case body 10 and sealing plate 20 (excluding the positive terminal 40 and the negative terminal 50) the of assembly 100A disposed on the workpiece disposition unit U1. The distance between the upper end of the case body 10 and the sealing plate 20 (excluding the positive terminal 40 and the negative terminal 50) of the assembly 100A disposed on the workpiece disposition unit U1 and the passage point of the detection light is, for example, 3 to 10 mm. One of the detection sensors includes a light projecting unit and a light receiving unit disposed so that detection light passes through the long side clamp C1 side of the positive terminal 40 and the negative terminal 50 of the assembly 100A disposed on the workpiece disposition unit U1. The other detection sensor includes a light projecting unit and a light receiving unit disposed so that detection light passes through the long side clamp C2 side of the positive terminal 40 and the negative terminal 50 of the assembly 100A disposed on the workpiece disposition unit U1. Such a detection sensor in the welding apparatus 200 can detect whether or not the assembly 100A on the workpiece placement unit U1 is displaced (floated) from the required position in the height direction. In the laser welding, the laser irradiation point (the position of the irradiation spot) may be displaced due to a displacement in the height direction of the workpiece (the assembly 100A in this embodiment). In particular, when laser welding is performed using a galvanometer scanner type laser unit, slight displacement in the height direction of the workpiece can easily cause the laser irradiation spot to shift, and therefore it is important to detect whether or not the workpiece is displaced (floated) from the required position in the height direction.

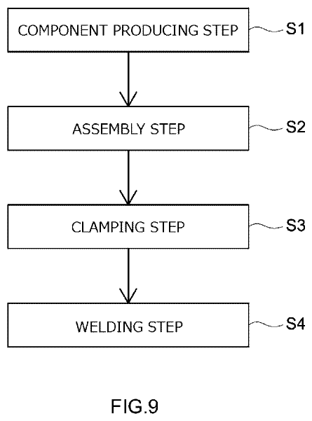

FIG. 9 is a flowchart showing an example of a method for manufacturing the power storage device 100. The method for manufacturing the power storage device 100 corresponds to the manufacturing method of the power storage device according to one embodiment of the present invention, and includes a component producing step S1, an assembly step S2, a clamping step S3, and a welding step S4.

In the component producing step S1, various components are produced and prepared such as the case body 10, the sealing plate 20, the electrode body 30, the positive terminal 40, and the negative terminal 50. The case body 10 can be produced by, for example, drawing a metal plate. The sealing plate 20 is prepared with the positive terminal 40 and the negative terminal 50 attached thereto. Specifically, the sealing plate 20 can be prepared by machining a rectangular flat plate, such as by drilling holes, and then attaching electrode terminals (positive terminal 40, negative terminal 50) and the like thereto. The electrode body 30 can be manufactured, for example, by laminating the above-mentioned separator (first separator), the positive electrode, the separator (second separator), and the negative electrode in this order, and then winding the laminated body.

In the assembly step S2, first, the positive terminal 40 and the negative terminal 50 attached to the sealing plate 20 are electrically connected to the electrode body 30. Specifically, first, the positive electrode collection unit 31 is connected to the above-mentioned positive electrode tab group (the plurality of stacked positive electrode tabs) in the electrode body 30, and the negative electrode collection unit 32 is connected to the above-mentioned negative electrode tab group (the plurality of stacked negative electrode tabs). These connection methods include, for example, ultrasonic bonding. Thereafter, the positive terminal 40 and the negative terminal 50 attached to the sealing plate 20 are respectively connected to the positive electrode collection unit 31 and the negative electrode collection unit 32. In this way, an assembly is obtained in which the sealing plate 20, the electrode body 30, the positive terminal 40, the negative terminal 50, etc. are assembled. Examples of the method for connecting the terminal and the power collection unit include laser welding and crimping.

In the assembly step S2, the electrode body 30 side of the above-mentioned assembly is then inserted into the case body 10 through the opening 10A, and the sealing plate 20 is attached to the edge portion 10E of the case body 10 so as to seal the opening 10A. In order to position the sealing plate 20 in the Z direction, a step (not shown) may be provided on the inner surface of the case at the edge portion 10E of the case body 10. When such a step is formed at the edge portion 10E, the sealing plate 20 can be attached to the edge portion 10E so that the peripheral edge of the sealing plate 20 rests on the step.

The assembly 100A of the case body 10 and the sealing plate 20 obtained through the assembly step S2 is disposed on the workpiece disposition unit U1. Specifically, the assembly 100A is disposed on the workpiece disposition unit U1 with the opening 10A of the case body 10, to which the sealing plate 20 is attached, facing upward.

Next, in the clamping step S3, the edge portion 10E and its vicinity of the case body 10 in the assembly 100A on the workpiece disposition unit U1 are pressed against the sealing plate 20 by the clamp unit U3. Specifically, the long side clamps C1, C2 of the clamp unit U3 are brought closer to each other by the actuator and are respectively brought into contact with the wide side surfaces 14, 15 of the case body 10, and then the edge portion 10E of the case body 10 and its vicinity are pressed in the thickness direction (X direction) of the case body 10. At the same time, the short side clamps C3, C4 are moved closer to each other by the actuator and are respectively abutted against the narrow side surfaces 12, 13 of the case body 10, and then the edge portion 10E of the case body 10 and its vicinity are pressed in the width direction (Y direction) of the case body 10.

By pressing as described above in the clamping step S3, the edge portion 10E of the case body 10 is positioned with respect to the sealing plate 20. In the case body 10 after molding, outward bulging is likely to occur particularly in the center portions of the wide side surfaces 13, 14 in the width direction Y, in its natural state. With the sealing plate 20 being attached to the opening 10A or edge portion 10E of the case body 10, a gap is likely to occur between the case body 10 and the sealing plate 20. In contrast, after the sealing plate 20 is attached to the edge portion 10E of the case body 10, the edge portion 10E of the case body 10 and its vicinity is pressed against the sealing plate 20 using the clamp unit U3, and thereby the bulge can be corrected. This makes it possible to prevent a gap from occurring between the case body 10 and the sealing plate 20. The narrower the gap, the more likely it is that welding spatter during laser welding is prevented from intrusion into the case body 10 or the case C.

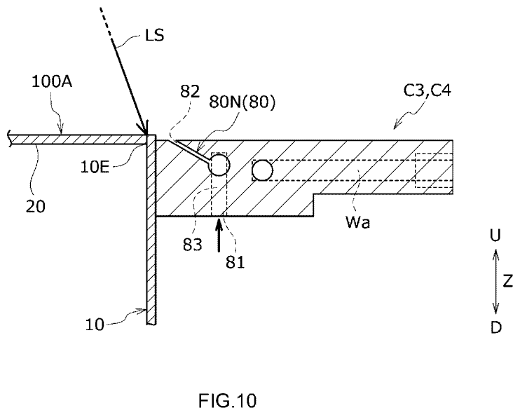

Next, in the welding step S4, as shown in FIG. 10, the boundary between the case body 10 and the sealing plate 20 is irradiated with the laser light LS from the laser irradiation device U2 to laser-weld the case body 10 and the sealing plate 20 in the assembly 100A (the structure inside the case body 10 is not shown in FIG. 10). The laser irradiation device U2 scans the assembly 100A with the laser light LS at an irradiation point (illuminated spot) along the boundary (intended welding line) between the case body 10 and the sealing plate 20.

The types of laser light LS include, for example, a ring mode laser, a Gaussian laser, and a flat-top laser. Examples of ring mode lasers include a single-ring type ring mode laser and a ring mode laser having a center portion and a ring portion surrounding the center portion in the laser beam transverse section. From the viewpoint of suppressing the generation of welding spatter during welding, a ring mode laser is preferred having a center portion and a ring portion surrounding the center portion in the laser beam transverse section. The latter ring mode laser is suitable for forming a keyhole of the desired depth at the center of the irradiation spot at and near the laser irradiation point on the welding object, while forming a molten pool at a relatively gentle temperature distribution around the keyhole. Forming a keyhole having the desired depth is useful for forming a welded portion having a sufficient weld depth. The gradual temperature distribution of the molten area is useful for stabilizing the molten area (suppress waviness), and therefore useful for suppressing the generation of welding spatter. In the welding in the welding step S4, the irradiation spot diameter of the laser light LS is, for example, 250 to 950 μm, the output of the laser light LS is, for example, 5000 to 6000 W, and the passing speed of the laser light LS is, for example, 150 to 200 mm/s.

When using the ring mode laser having the center portion and the ring portion as the laser light LS, the output of the center portion is preferably 500 to 2500 W from the viewpoint of forming a sufficient molten portion and a sufficient keyhole by the laser irradiation. When using the ring mode laser having the center portion and the ring portion as the laser light LS, the output of the ring portion is preferably 2800 to 6000 W from the viewpoint of ensuring an appropriate welding depth for the welded portion.

When using the ring mode laser having the center portion and the ring portion as the laser light LS, the diameter of the center portion (diameter at the laser irradiation point or spot diameter) is preferably not less than 250 μm, more preferably not less than 270 μm, from the viewpoint of forming the keyhole having an appropriate size at the laser irradiation point and suppressing or preventing the formation of a blowhole, and is preferably not more than 450 μm, more preferably not more than 350 μm, from the viewpoint of suppressing or preventing the formation of a through keyhole at the laser irradiation point. When using the ring mode laser having the center portion and the ring portion as the laser light LS, the diameter of the ring portion (outer diameter at the laser irradiation point) is preferably not less than 800 μm from the viewpoint of ensuring heat input to the case body 10 side near the laser irradiation point and forming an appropriate molten zone, and is preferably not more than 1000 μm from the viewpoint of ensuring the energy density at the laser irradiation point and forming an appropriate molten portion.

During the welding step S4, the inert gas (e.g., nitrogen gas) is supplied to the welding point by the inert gas supply unit U4. Specifically, the inert gas is supplied from the outlet port 72 of the gas supply block 70B on the long side clamp C1 toward the boundary between the wide side surface 14 and the sealing plate 20 in the assembly 100A (the one long-side intended welding line). On the other hand, the inert gas is supplied from the outlet port 72 of the gas supply block 70B on the long side clamp C2 toward the boundary between the wide side surface 15 and the sealing plate 20 in the assembly 100A (the other long-side intended welding line). The inert gas is supplied from the outlet port 82 of the nozzle 80N formed in the short side clamp C3 toward the boundary between the narrow side surface 12 and the sealing plate 20 in the assembly 100A (the one short-side intended welding line). On the other hand, the inert gas is supplied from the outlet port 82 of the nozzle 80N formed in the short side clamp C4 toward the boundary between the narrow side surface 13 and the sealing plate 20 in the assembly 100A (the other short-side intended welding line).

In supplying the inert gas, the air velocity (blowing speed) of the inert gas (e.g., nitrogen gas, etc.) is, for example, 3 to 5 m/s. The distance from each outlet port to the welding point is, for example, not more than 12 mm, preferably not more than 10 mm, more preferably not more than 7 mm, and still more preferably not more than 5 mm.

As described above, the outlet port 72 of the gas supply block 70B in the inert gas supply unit U4 is opened so that the corresponding long-side intended welding line is positioned within the outlet port 72 in the height direction. From such an outlet port 72, the inert gas is ejected in a substantially horizontal direction toward the long-side intended welding line. That is, the angle formed by the gas blowing direction of the outlet port 72 with respect to the horizontal direction is approximately 0°.

As described above, the outlet port 82 of each nozzle 80N in the inert gas supply unit U4 is positioned below the corresponding short-side intended welding line in the height direction. The outlet port 82 of such a nozzle 80N blows the inert gas toward the boundary between the case body 10 and the sealing plate 20 in the assembly 100A disposed on the workpiece disposition unit U1 from a position lower than the upper ends of the case body 10 and the sealing plate 20 in the assembly 100A. Regarding the gas supply block 70B described above, the outlet port 72 may also be provided at a position that blows the inert gas from below the long-side intended welding line.

By the above-described welding step S4, the edge portion 10E of the case body 10 and the sealing plate 20 are joined over the entire area, and thereby an airtightly sealed case C is formed.

In this embodiment, a temporary welding step may be performed after the clamping step S3 and before the welding step S4. In the temporary welding step, each of a plurality of points on the boundary (the planned welding line) between the case body 10 and the sealing plate 20 in the assembly 100A is irradiated with the laser beam LS, and the plurality of locations are spot-welded. When performing the temporary welding step, the above-described welding step S4 is then performed.

After the welding step S4, various steps are appropriately carried out, such as a liquid injection step in which electrolyte injected into the case body 10, an aging step in which the energy storage device 100 is charged and then left for a predetermined period of time, and an inspection step in which internal short circuits, etc., of the energy storage device 100 are inspected. In the liquid injection step, specifically, the electrolyte is injected into the inside of the case body 10 through the injection hole formed on the case C, and then the injection hole is closed. In this way, the above-described power storage device 100 can be manufactured.

The power storage device 100 can be used for various applications. The electricity storage device 100 can be suitably used as a power source (driving power source) for a motor mounted on a vehicle such as a passenger car or truck. The type of vehicle is not particularly limited, but examples include plug-in hybrid electric vehicles (PHEVs), hybrid electric vehicles (HEVs), and battery electric vehicles (BEVs).

The welding apparatus 200 includes a first supply unit 70 configured to supply the inert gas to the above-mentioned long-side intended welding line of the assembly 100A during laser welding, as well as a second supply unit 80 or nozzle 80N configured to supply the inert gas to the above-mentioned short-side intended welding line. In accordance with such a configuration, the inert gas can be blown out or discharged from the vicinity of the laser irradiation spot toward the spot along the entire length of the intended welding line. This makes it possible to perform laser welding under a stable inert gas atmosphere, thereby ensuring satisfactory welding quality by preventing or suppressing the formation of an oxide film on the surface.

In the welding apparatus 200, as described above, the short side clamps C3, C4 are each positioned below (at a lower position) than the upper ends of the case body 10 and the sealing plate 20 in the assembly 100A disposed on the workpiece disposition unit U1. Such a configuration is suitable for avoiding interference between the short side clamps C3, C4 and the detection light of the detection sensor described above, and therefore is suitable for ensuring the detection function of the detection sensor.

In the welding apparatus 200, as described above, the nozzle 80N of the second supply unit 80 in the inert gas supply unit U4 is positioned below (at a lower position) than the upper ends of the case body 10 and sealing plate 20 in the assembly 100A disposed on the workpiece disposition unit U1. The outlet port 82 of the nozzle 80N blows or discharges the inert gas toward the boundary between the case body 10 and the sealing plate 20 in the assembly 100A disposed on the workpiece disposition unit U1 from a position lower than the upper ends of the case body 10 and the sealing plate 20 in the assembly 100A. Such a configuration is suitable for suppressing cumulative deposition of fumes generated during laser welding in the vicinity of the laser welding point within the apparatus. When the inert gas is supplied or sprayed onto a laser welding point from above, fumes generated during laser welding tend to be carried by the inert gas flow and deposit near the laser welding point, and the amount of deposition tends to increase as the number of times the welding device is operated (number of laser welding operations) increases. The welding apparatus 200 is adapted to avoid such problems. The reduced amount of fume deposition helps reduce maintenance of the welding apparatus 200. Moreover, the configuration in which the nozzle 80N is positioned below (at a lower position) than the upper ends of the case body 10 and sealing plate 20 in the assembly 100A disposed on the workpiece disposition unit U1 is suitable for avoiding interference between the nozzle 80N and the detection light of the above-mentioned detection sensor, and is therefore suitable for ensuring the detection function of the detection sensor.

In the welding apparatus 200, as described above, the nozzle 80N of the inert gas supply unit U4 is provided on each of the short side clamps C3, C4 (holding members). Such a configuration is useful for reducing the space and size of the welding apparatus 200.

In the welding apparatus 200, as described above, the nozzle 80N in the inert gas supply unit U4 has an outlet port 82 on the upper surface Sa of the short side clamp (short side clamps C3, C4) in the clamp unit U3 and is formed in the shape of a slit extending along the narrow side surface (narrow side surfaces 12, 13) of the case body 10. Such a configuration is suitable for positioning the outlet port 82 close to the laser irradiation point (welding point) during the laser welding. Moreover, the slit-shaped nozzle 80N is suitable for spraying the inert gas evenly onto one side (one short side in the above embodiment) of the welding portion at the peripheral edge of the substantially rectangular sealing plate 20.

In the welding apparatus 200, the nozzle 80N in the inert gas supply unit U4 has, as described above, an upper wall 83a and a lower wall 83b that face each other and define a flow path 83 (gas flow path), and the upper wall 83a and the lower wall 83b are inclined upward toward one side surface of the case body 10 (the narrow side in the above embodiment). By adjusting the inclination angles of the upper wall 83a and the lower wall 83b, it is possible to appropriately adjust the inclination angle of the flow path. This is helpful to adjust a blowing out angle from outlet port 82.

In the welding apparatus 200, the nozzle 80N in the inert gas supply unit U4 is formed by cutting a slit into the holding member (the short side clamps C3, C4 in the above embodiment), as described above. Such a configuration is suitable for efficiently forming the nozzle 80N without adding any additional components.

In the welding device 200, as described above, the distance between the outlet port 82 in the inert gas supply unit U4 and the boundary between the case body 10 and the sealing plate 20 is preferably not more than 10 mm. Such a configuration is helpful to suitably spray the inert gas such as nitrogen gas onto the laser welding point.

The technology disclosed herein has been described in detail above. Unless otherwise specified, the present invention is not limited to the embodiments and the like described herein. Moreover, the technology disclosed herein can be modified in various ways, and as long as no particular problems arise, the components and processes mentioned herein can be omitted or combined as appropriate. Moreover, this specification also includes the disclosures described in the following sections.

### Section 1:

A welding apparatus configured to weld a case body and sealing plate of a power storage device to each other, the case body having an opening, the sealing plate attached to the opening, the welding apparatus comprising:
a workpiece disposition uniton which an assembly of the case body and the sealing plate is disposed with the opening facing upward with the sealing plate attached;
a laser irradiation device disposed above the workpiece disposition unit; and
an inert gas supply device, wherein
the inert gas supply device comprises a nozzle at a position that is lower than an upper end of the case body of the assembly disposed on the workpiece disposition unit, and
the nozzle has an outlet port configured to blow inert gas toward a boundary between the case body and the sealing plate from a position lower than the upper end of the case body within the assembly, with respect to the assembly disposed on the workpiece disposition unit.

### Section 2:

The welding apparatus according to Section 1 further comprising a holding member configured to hold the case body, wherein the nozzle is provided on the holding member.

### Section 3:

The welding apparatus according to Section 2, wherein
the case body is configured in a substantially rectangular parallelepiped,
the sealing plate is configured in a substantially rectangular plate shape,
the holding member is positioned below an upper end of the case body and abuts against one side surface of the case body, and
the nozzle has the outlet port on an upper surface of the holding member and is formed in a shape of a slit extending along the one side surface of the case body.

### Section 4:

The welding apparatus according to Section 3, wherein the one side surface is a surface including a short side of the case body.

### Section 5:

The welding apparatus according to Section 3 or 4, wherein
the nozzle has an upper wall and a lower wall facing each other and defining a gas flow path, and
the upper wall and the lower wall are inclined upward toward the one side surface of the case body.

### Section 6:

The welding apparatus according to any one of Sections 3-5, wherein the nozzle is formed by cutting a slit into the holding member.

### Section 7:

The welding apparatus according to any one of Sections 1-6, wherein a distance between the outlet port and the boundary is not more than 10 mm.

### Section 8:

A method for manufacturing a power storage device, the power storage device comprising a case body and a sealing plate, the case body having an opening, the sealing plate attached to the opening, the method comprising:
a holding step of holding an assembly of the case body and the sealing plate with the opening facing upward with the sealing plate attached; and
a welding step of laser welding the case body and the sealing plate to each other while supplying an inert gas toward a boundary between the case body and the sealing plate in the assembly, wherein
in the welding step, the inert gas is blown out toward the boundary between the case body and the sealing plate from an outlet port included in a nozzle positioned below an upper end of the case body in the assembly.

### Section 9:

The method for manufacturing the power storage device according to Section 8, wherein
in the holding step, the case body is held by a holding member abutting against the case body, and
the nozzle is provided in the holding member.

### Section 10:

The method for manufacturing the power storage device according to Section 9, wherein
the case body is configured in a substantially rectangular parallelepiped,
the sealing plate is configured in a substantially rectangular plate shape,
the holding member is positioned below an upper end of the case body and abuts against one side surface of the case body, and
the nozzle has the outlet port on an upper surface of the holding member and is formed in a shape of a slit extending along the one of the case body.

### Section 11:

The method for manufacturing the power storage device according to Section 10, wherein the one side surface is a surface including a short side of the case body.

### Section 12:

The method for manufacturing the power storage device according to Section 10 or 11, wherein
the nozzle has an upper wall and a lower wall facing each other and defining a gas flow path, and
the upper wall and the lower wall are inclined upward toward the one side surface of the case body.

### Section 13:

The method for manufacturing the power storage device according to any one of Sections 10-12, wherein the nozzle is formed by cutting a slit into the holding member.

### Section 14:

The method for manufacturing the power storage device according to any one of Sections 8-13, wherein the distance between the outlet port and the boundary is not more than 10 mm.

What is claimed is:

1. A welding apparatus configured to weld a case body and sealing plate of a power storage device to each other, the case body having an opening, the sealing plate attached to the opening, the welding apparatus comprising:
a workpiece disposition unit on which an assembly of the case body and the sealing plate is disposed with the opening facing upward with the sealing plate attached;
a laser irradiation device disposed above the workpiece disposition unit; and
an inert gas supply device, wherein
the inert gas supply device comprises a nozzle at a position that is lower than an upper end of the case body of the assembly disposed on the workpiece disposition unit, and
the nozzle has an outlet port configured to blow inert gas toward a boundary between the case body and the sealing plate from a position lower than the upper end of the case body within the assembly, with respect to the assembly disposed on the workpiece disposition unit.

2. The welding apparatus according to claim 1 further comprising a holding member configured to hold the case body, wherein the nozzle is provided on the holding member.

3. The welding apparatus according to claim 2, wherein
the case body is configured in a substantially rectangular parallelepiped,
the sealing plate is configured in a substantially rectangular plate shape,
the holding member is positioned below the upper end of the case body and abuts against one side surface of the case body, and
the nozzle has the outlet port on an upper surface of the holding member and is formed in a shape of a slit extending along the one side surface of the case body.

4. The welding apparatus according to claim 3, wherein the one side surface is a surface including a short side of the case body.

5. The welding apparatus according to claim 3, wherein
the nozzle has an upper wall and a lower wall facing each other and defining a gas flow path, and
the upper wall and the lower wall are inclined upward toward the one side surface of the case body.

6. The welding apparatus according to claim 3, wherein the nozzle is formed by cutting a slit into the holding member.

7. The welding apparatus according to claim 1, wherein a distance between the outlet port and the boundary is not more than 10 mm.

8. A method for manufacturing a power storage device, the power storage device comprising a case body and a sealing plate, the case body having an opening, the sealing plate attached to the opening, the method comprising:
a holding step of holding an assembly of the case body and the sealing plate with the opening facing upward with the sealing plate attached; and
a welding step of laser welding the case body and the sealing plate to each other while supplying an inert gas toward a boundary between the case body and the sealing plate in the assembly, wherein
in the welding step, the inert gas is blown out toward the boundary between the case body and the sealing plate from an outlet port included in a nozzle positioned below an upper end of the case body in the assembly.

9. The method for manufacturing the power storage device according to claim 8, wherein
in the holding step, the case body is held by a holding member abutting against the case body, and
the nozzle is provided in the holding member.

10. The method for manufacturing the power storage device according to claim 9, wherein
the case body is configured in a substantially rectangular parallelepiped,
the sealing plate is configured in a substantially rectangular plate shape,
the holding member is positioned below the upper end of the case body and abuts against one side surface of the case body, and
the nozzle has the outlet port on an upper surface of the holding member and is formed in a shape of a slit extending along the one side surface of the case body.

11. The method for manufacturing the power storage device according to claim 9, wherein the one side surface is a surface including a short side of the case body.

12. The method for manufacturing the power storage device according to claim 10, wherein
the nozzle has an upper wall and a lower wall facing each other and defining a gas flow path, and
the upper wall and the lower wall are inclined upward toward the one side surface of the case body.

13. The method for manufacturing the power storage device according to claim 10, wherein the nozzle is formed by cutting a slit into the holding member.

14. The method for manufacturing the power storage device according to claim 8, wherein the distance between the outlet port and the boundary is not more than 10 mm.
